(19) United States
(12) Patent Application Publication
(10) Pub. No.: US 2014/0321699 A1
(43) Pub. Date: Oct. 30, 2014

(54) Method For Characterizing Confined Fission Tracks in Solids

(71) Applicants: Raymond Allen Donelick, Viola, ID (US); Calvin Loncaric, Viola, ID (US); Colin O"Byrne, Viola, ID (US); Leif Gaebler, Viola, ID (US); Thea Rose Osinski, Los Angeles, CA (US); Zachary Dodds, Claremont, CA (US); Mary Rachel Stimson, Claremont, CA (US); Peter Adrien, Claremont, CA (US); Colin Bundschu, Claremont, CA (US); Elijah Omernick, Claremont, CA (US); Christopher Stone, Claremont, CA (US)

(72) Inventors: Raymond Allen Donelick, Viola, ID (US); Calvin Loncaric, Viola, ID (US); Colin O"Byrne, Viola, ID (US); Leif Gaebler, Viola, ID (US); Thea Rose Osinski, Los Angeles, CA (US); Zachary Dodds, Claremont, CA (US); Mary Rachel Stimson, Claremont, CA (US); Peter Adrien, Claremont, CA (US); Colin Bundschu, Claremont, CA (US); Elijah Omernick, Claremont, CA (US); Christopher Stone, Claremont, CA (US)

(73) Assignee: Apatite to Zircon, Inc., Viola, ID (US)

(21) Appl. No.: 13/874,458

(22) Filed: Apr. 30, 2013

(51) Int. Cl. G06K 9/00; G01B 11/14

(52) U.S. Cl. CPC G06K 9/00624; G01B 11/14
USPC 382/103

(57) ABSTRACT

A method for determining the position and its statistical uncertainty of a confined fission track in a crystal based on detecting confined fission track tips in a series of transmitted light images. A computer software program for: detecting confined fission track tips in a series of transmitted light images and assessing the viability of each tip using a scoring equation; writing to and loading from a computer database of confined fission tracks; modifying the scoring equation for assessing confined fission track tip viability based on the contents of the computer database. A computer database consisting of transmitted light images of confined fission tracks. A method for determining the statistical probability that a confined fission track is a real confined fission track.

### BRIEF SUMMARY

This invention includes a method to determine the positions in a crystal of the tips of a confined fission track, comprised of: producing a series of transmitted light images; detecting both of the two tips of the confined fission track; determining the positions and their statistical uncertainties of the two tips the confined fission track in the crystal. The method also is comprised of: accepting or rejecting as real a confined fission track based on the statistical uncertainties of the positions of the two tips of the fission track; accepting or rejecting as real a confined fission track based on the judgment of a human being; capturing a reflected light image of the crystal surface and determining the size of one or more etch figures on the crystal surface. The prior art requires greater human labor and provides less information compared to this invention, being comprised of: determining the positions in a crystal of the tips of a confined fission track manually; not determining the statistical uncertainties of the positions in a crystal of the tips; determining the size of one or more etch figures on the crystal surface manually.

This invention includes a computer software program containing instructions to detect the tips of a confined fission track, comprised of: loading a series of transmitted light images; detecting both of the two tips of the confined fission track; determining the positions and their statistical uncertainties of the two tips in the crystal; writing transmitted light images to a database; loading transmitted light images from a database. The computer software program also contains instructions comprised of: assessing the viability, using a scoring equation, of a tip of a confined fission; modifying the confined fission track tip scoring equation based on the contents of a confined fission track database; presenting to a human being for viewing by the human being a transmitted light image of the tip of a confined fission track; calculating the statistical probability that a confined fission track is a real confined fission track. The prior art does not comprise the capabilities of the computer software disclosed here.

This invention includes a computer database of confined fission tracks comprised of: allowing a confined fission track to be inserted; allowing a confined fission track to be removed; representing each confined fission track in the database by one or more transmitted light images formed by the transmission of light through a crystal. The computer database also is comprised of: assigning to each inserted confined fission track a statistical probability that the confined fission track is a real confined fission track; restricting the insertion of all confined fission tracks to a human being; restricting the removal of a confined fission track to the same human being to which insertion of confined fission tracks is restricted. The computer database also is comprised of: restricting the insertion of all confined fission tracks to a any member of a group of human beings; restricting the removal of a confined fission track to any member of the same group of human beings to which insertion of confined fission tracks is restricted. The prior art does not comprise such a database as is disclosed here.

This invention includes a method of determining the statistical probability that a confined fission track is a real confined fission track, comprised of: producing a series of transmitted light images; detecting the two tips of the confined fission track; detecting the two sides of the confined fission track; assessing the viability, using a scoring equation, of each confined fission track tip; assessing the viability, using a scoring equation, of each confined fission track side. The method is also comprised of: assessing the viability of each confined fission track tip and side based on the judgment of human being; assessing the viability of each confined fission track tip and side based on the collective judgment of group of human beings. The prior art allows only two, discrete values for the statistical probability that a confined fission track is a real confined fission track: 0 and 1. The method disclosed here allows for any value between 0 and 1, inclusive.

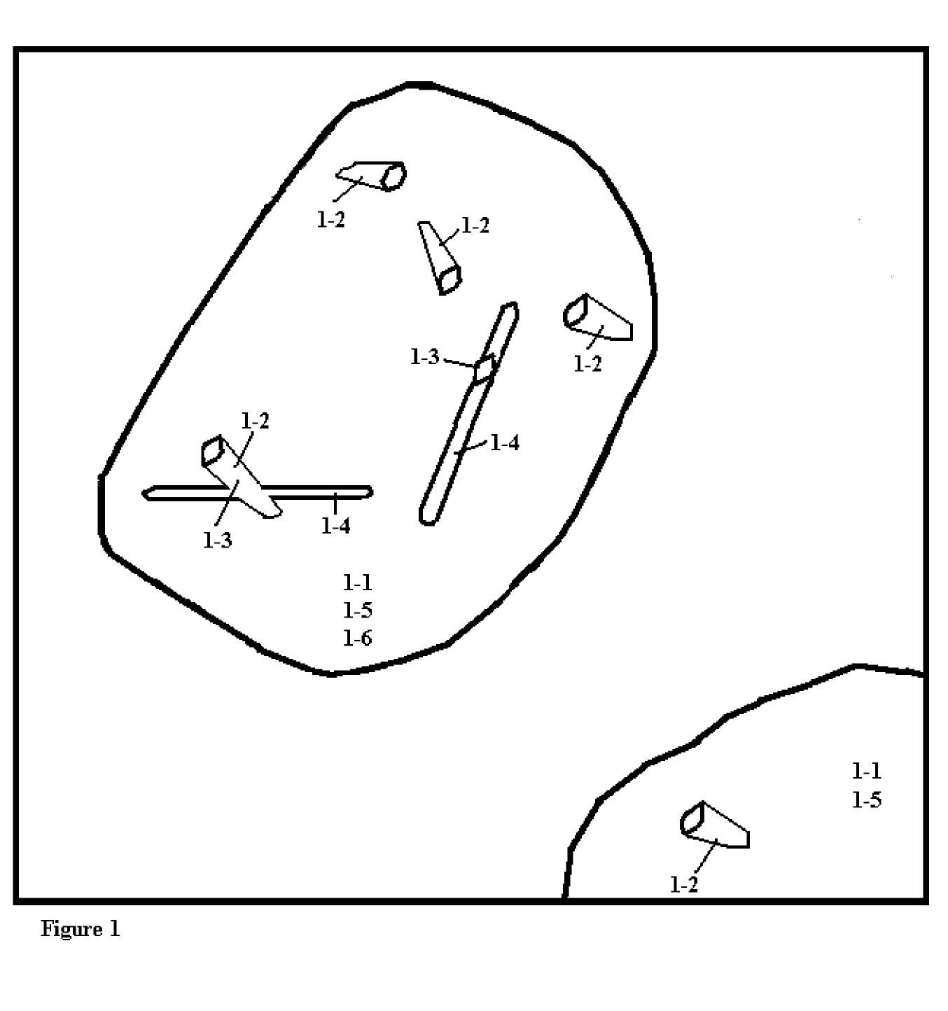

FIG. 1. Crystal mount.

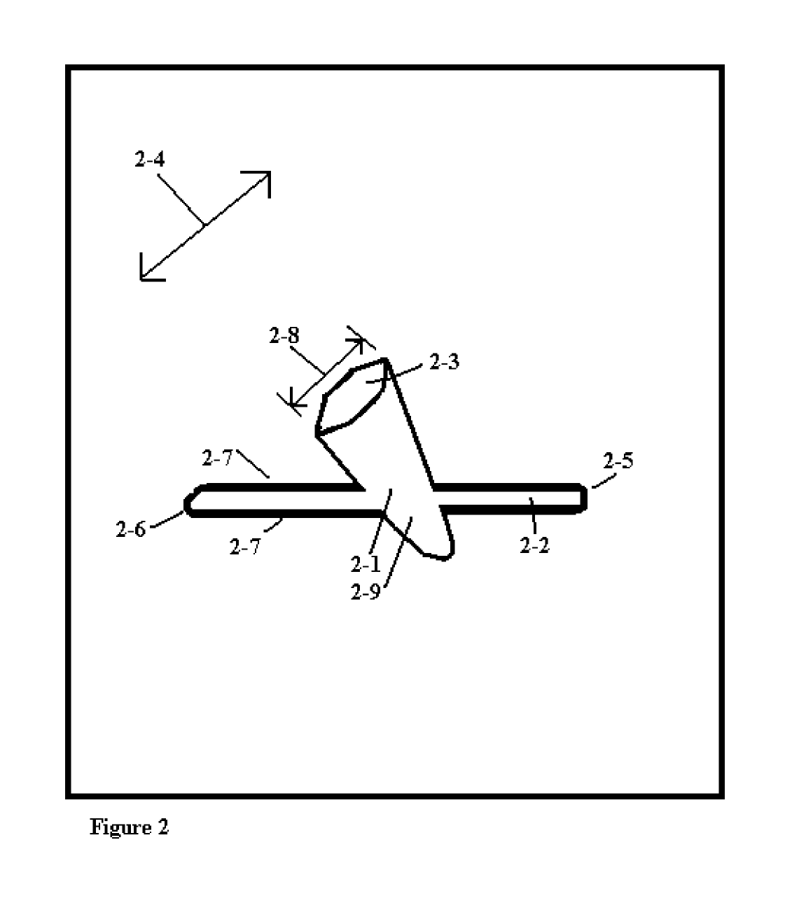

FIG. 2. Subset of crystals containing fission semi-tracks and confined fission tracks.

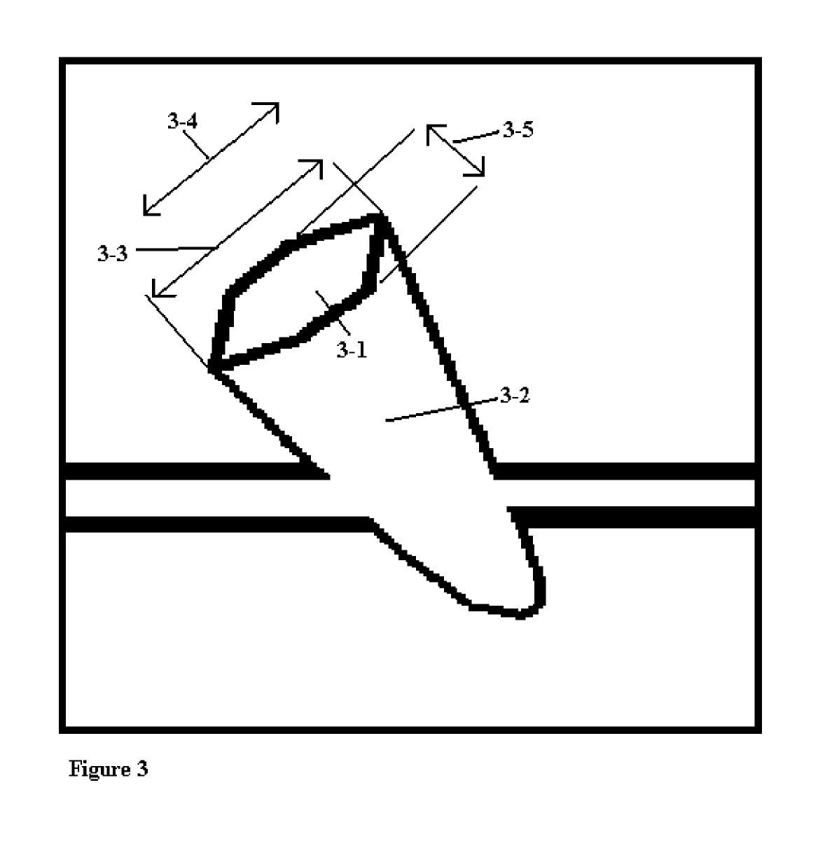

FIG. 3. Etch figure formed by a fission semi-track.

### DESCRIPTION OF THE INVENTION

### Background

A latent fission track is a single, approximately linear, randomly oriented zone of molecular damage in a host solid resulting from the fission of a single, fissile atomic nucleus. latent fission tracks have cross-sectional diameters on the order of 10s of Angstroms and lengths on the order of 1-20 micrometers and they are individually invisible using optical microscopy. Fissile atomic nuclei that form latent fission tracks include ²³⁵U, ²⁵²C^{a,} and ²³⁸U. Latent fission tracks may be created within a solid under carefully controlled laboratory conditions by the thermal-neutron-induced fission of ²³⁵U nuclei contained within the solid. In certain natural solids, such as the mineral apatite or volcanic glass, latent fission tracks form and accumulate by the spontaneous fission of ²³⁸U nuclei within the solid, some having formed shortly after the mineral crystallized or glass solidified, some having formed very recently, and some having formed during the intervening time span. Fissile ²⁵²Cf nuclei placed in proximity to a solid surface may be used to create latent fission tracks on that surface that may be used during specialized laboratory and industrial processes.

Latent fission tracks derived from the fission of ²³⁵U or ²³⁸U nuclei are randomly oriented within their host solid and exhibit a number per unit volume that correlates with the number per unit volume of parent fissile nuclei within the host solid, all other environmental factors, such as temperatures experienced by the latent fission tracks and the chemical state of the host solid, being equal. In a natural solid containing fissile ²³⁸U nuclei, latent fission tracks form throughout time due to the predictable nuclear fission of the ²³⁸U nuclei. When a natural solid is maintained at sufficiently low temperatures, new latent fission tracks accumulate and previously formed latent fission tracks experience slow, spontaneous conversion back to undamaged solid but they remain as latent fission tracks. Therefore, at sufficiently low temperatures, the number of latent fission tracks per unit volume in a natural solid correlates with both the ²³⁸U nuclei per unit volume and the duration of time over which latent fission tracks have accumulated. Knowledge of the number of latent fission tracks per unit volume and the number of ²³⁸U nuclei per unit volume in a natural solid provides the analyst a basis for age dating of the natural solid and a basis for deciphering aspects of Earth's history

The number per unit volume of latent fission tracks derived from the thermal-neutron-induced fission of ²³⁵U nuclei correlates with both the number of ²³⁵U nuclei per unit volume in the host solid and the integrated flux of thermal neutrons to which the solid was exposed. latent fission tracks derived from induced fission of ²³⁵U nuclei may be used to create and study latent fission tracks under carefully controlled laboratory conditions, and they are commonly thought to be indistinguishable upon formation from their ²³⁸U-derived counterparts due to the close similarities between the ²³⁵U and ²³⁸U nuclear fission processes.

A latent fission track must be rendered visible to enable study by a human being (herein, analyst) of its characteristics. A commonly applied process is to dissolve the latent fission track in a chemical mixture and then enlarge the resultant void space to a size visible using an optical microscope. This process is commonly referred to as etching. To accomplish etching, the solid containing latent fission tracks is polished to expose an interior plane of the solid. Some of the randomly oriented latent fission tracks may intersect this exposed interior plane. The exposed interior plane is then placed in contact with an appropriate chemical mixture. The chemical mixture dissolves any latent fission track that intersects the exposed interior plane at a greater rate than it does the surrounding undamaged solid. Following initial, relatively rapid dissolution of the latent fission track, further exposure of the undamaged solid to the chemical mixture gives rise to enlargement of the void in the undamaged solid where the latent fission track had been. Contact between the exposed interior plane of the solid and the chemical mixture is terminated when the void where the latent fission track had been is large enough to be viewed using an optical microscope.

The void space where a latent fission track had intersected the polished and etched plane of the solid penetrates into the volume of the preserved solid and is commonly referred to as a fission semi-track because part of the latent fission track had been polished away during the process of exposing the interior plane. In some instances, a fission semi-track intersects another latent fission track that is wholly confined in the preserved solid, permitting the chemical mixture to reach and preferentially dissolve the wholly confined latent fission track and enlarge its resultant void space sufficiently for optical viewing by the analyst. Such a fission semi-track that provides a pathway for the chemical mixture to reach and dissolve a wholly confined latent fission track is commonly referred to as an etchant pathway. Any wholly confined latent fission track that is reached by the chemical mixture via an etchant pathway, is preferentially dissolved and its resultant void space enlarged sufficiently for optical viewing by the analyst, and exhibits visible tips at each end of its longest axis, is commonly referred to as a confined fission track (herein, also confined fission track). The definition of etchant pathway is broadened to include any continuous combination of fission semi-tracks, confined fission tracks, cracks, disruptions or defects in the solid molecular structure, or human-induced fission semi-tracks or other zones of damage to the solid molecular structure that connect the polished and etched plane of the solid to the wholly confined latent fission track.

Fission semi-tracks and confined fission tracks may be viewed by the analyst using an optical microscope. An optical microscope transmits light through and/or reflects light off of a solid surface containing fission semi-tracks and/or confined fission tracks and modifies the light pathways so that the micrometer-sized fission semi-tracks and confined fission tracks are made visible to and distinguishable by (henceforth, visible to) the analyst. Once visible to the analyst, either directly through the optical apparatus of the microscope or indirectly using a charge coupled device affixed to the optical microscope that permits display of the visible features on a computer display screen, features of the fission semi-tracks and/or confined fission tracks of interest to the analyst are measured and documented.

The number of ²³⁵U-derived or ²³⁸U-derived fission semi-tracks per unit area of a polished and etched plane of a solid correlates with the number of latent fission tracks per unit volume of that same solid that existed before that solid was polished and etched. The number of ²⁵²Cf-derived fission semi-tracks per unit area of a treated solid surface correlates with the integrated flux of ²⁵²Cf-derived fission-fragment nuclei incident upon the surface.

The intersection between a fission semi-track and the polished and etched plane of the solid yields a well-defined geometrical shape commonly referred to as an etch figure. Etch figures exhibit characteristics, such as maximum length and width, that depend on the duration of exposure of the polished and etched plane of the solid to the chemical mixture used for etching, the temperature of the chemical mixture during etching, the composition of the chemical mixture, and the orientation of the fission semi-track relative to the polished and etched plane of the solid. Etch figures also exhibit characteristics, such as maximum length, maximum width, and symmetry or asymmetry, that depend on the nature of the polished and etched plane itself, including the chemical composition of the solid, the physical properties of the solid, and, for anisotropic solids such as anisotropic crystals, the crystal lattice plane represented by the polished and etched plane of the solid.

The ideal fission semi-track represents the etched void space left by the dissolution of a latent fission track that had intersected the polished and etched plane of the solid. The ideal fission semi-track is randomly oriented like its latent fission track precursor, and exhibits a range of possible end-to-end lengths, from very short, for the case where most of the latent fission track had been polished away, to long, for the case where a small fraction of the latent fission track had been polished away. In plan view, the ideal fission semi-track projects a complete and closed geometrical figure to the analyst when viewed using an optical microscope comprised of visible traces of the void space left by the dissolution of the latent fission track. One end of the ideal fission semi-track is composed on an etch figure and the other end is composed of the dissolved latent fission track tip trace. Between the two ends of the ideal fission semi-track are sub-parallel dissolved latent fission track side traces that connect the two ends and converge at the dissolved latent fission track tip trace.

A real fission semi-track may be comprised of a complete and closed geometrical figure visible to the analyst, having as a direct analog an ideal fission semi-track. A real fission semi-track may also have any portion of its etch figure, dissolved latent fission track tip trace, and/or dissolved latent fission track side traces rendered invisible to the analyst. Henceforth, fission semi-track refers to real fission semi-track. Part or all of the etch figure end may be rendered invisible to the analyst by overlapping, adjacent etch figures, cracks, other etched features, or other imperfections on the polished and etched plane of the solid. Latent fission track tip and side traces may be rendered partially or wholly invisible to the analyst by any combination of intersecting fission semi-tracks, confined fission tracks, cracks, disruptions or defects in the solid molecular structure, or human-induced fission semi-tracks or other zones of damage to the solid molecular structure that connect the polished and etched plane of the solid to the dissolved latent fission track traces.

When seeking to find a fission semi-track, the analyst seeks an etch figure or a part or parts thereof, an opposing dissolved latent fission track tip trace or a part or parts thereof, and/or intervening, sub-parallel dissolved latent fission track side traces or parts thereof. The analyst then attempts to envision, based on the accumulated memory of the analyst, the equivalent ideal fission semi-track for this combination of visible etch figure or a part or parts thereof, an opposing dissolved latent fission track tip trace or a part or parts thereof, and/or intervening, sub-parallel dissolved latent fission track side traces or parts thereof. If the analyst is able to positively envision an equivalent ideal fission semi-track for this combination of visible etch figure or a part or parts thereof, an opposing dissolved latent fission track tip trace or a part or parts thereof, and/or intervening, sub-parallel dissolved latent fission track side traces or parts thereof, the analyst accepts the combination of visible etch figure or a part or parts thereof, an opposing dissolved latent fission track tip trace or a part or parts thereof, and/or intervening, sub-parallel dissolved latent fission track side traces or parts thereof as a fission semi-track and adds this new fission semi-track to the accumulated memory of the analyst. The greater the fraction visible of properly positioned and oriented etch figure or a part or parts thereof, an opposing dissolved latent fission track tip trace or a part or parts thereof, and/or intervening, sub-parallel dissolved latent fission track side traces or parts thereof, the greater is the confidence of the analyst that this combination of visible etch figure or a part or parts thereof, an opposing dissolved latent fission track tip trace or a part or parts thereof, and/or intervening, sub-parallel dissolved latent fission track side traces or parts thereof is a fission semi-track. The analyst is never fully certain that these visible etch figure or a part or parts thereof, an opposing dissolved latent fission track tip trace or a part or parts thereof, and/or intervening, sub-parallel dissolved latent fission track side traces or parts thereof are, in fact, a fission semi-track and the current art does not include a means of quantifying the degree of certainty.

A confined fission track preserves characteristics of its respective dissolved latent fission track including its position and orientation within the host solid, and its approximate length. Other features of a confined fission track may be useful to the analyst including its geometrical dimensions, its inclination angle to the observational optical axis, its depth below the polished and etched solid surface, and the number, size, characteristics, and positions of other preferentially dissolved features intersecting the confined fission track including, but not limited to, other fission semi-tracks and confined fission tracks.

For a confined fission track to provide information useful to the analyst, both of its tips must be visible to the analyst. It is known from natural solids containing ²³⁸U-derived latent fission tracks that a young latent fission track yields a confined fission track exhibiting a length from tip to tip that is usually greater than the length of a confined fission track derived from a latent fission track that formed millions of years ago, all other environmental factors being equal such as temperatures experienced since formation of the latent fission tracks, and resultant confined fission track crystallographic orientation. It is also known from laboratory experiments that a latent fission track that experienced relatively high temperatures yields a confined fission track exhibiting a length that is usually less than the length of confined fission track derived from a latent fission track that experienced relatively low temperatures, all other environmental factors being equal such as latent fission track ages and crystallographic orientations. This time and temperature dependence of the lengths of confined fission tracks provides the analyst a basis for deciphering aspects of Earth's history.

In plan view, the ideal confined fission track, if it existed, would project a complete and closed geometrical figure to the analyst when viewed using an optical microscope. This closed geometrical figure would be composed of two opposing tips, with each tip exhibiting a trace visible to the analyst that is concave inward toward the other, and with the tips connected to each other by two approximately parallel and continuous visible traces of the confined fission track sides.

The ideal confined fission track is never encountered in practice because only segments of, and never all of, the real confined fission track side traces are visible to the analyst. Henceforth, confined fission track refers to any real confined fission track. Therefore, the confined fission track projects visible tip traces and partially visible side traces to the analyst, forming an incomplete, open geometrical figure similar to that envisioned by the analyst for the ideal confined fission track but with parts of the side traces invisible. This is because a confined fission track is etched via an intersecting etchant pathway. At the intersection of the etchant pathway and the confined fission track, a segment of one or each of the confined fission track side traces must be dissolved rendering the dissolved portion or portions of the side traces invisible to the analyst. The confined fission track may also intersect other preferentially dissolves features, rendering additional parts of the side traces invisible to the analyst. Dissolution of any portion of the host solid that would otherwise reveal a visible portion of a confined fission track side trace causes a portion of the confined fission track side trace to be invisible to the analyst. A portion of the confined fission track side trace may be present but rendered invisible to the analyst if it is obscured by a more prominent feature in the host solid. A portion of the confined fission track side trace may be rendered invisible to the analyst if the pathways of the light in the optical microscope do not permit the trace to be resolved by the analyst.

When seeking to find a confined fission track, the analyst seeks two visible, opposing dissolved latent fission track tip traces. The analyst then looks for two approximately parallel dissolved latent fission track side traces, or visible portions thereof, between these opposing dissolved latent fission track tip traces. The analyst then attempts to envision, based on the accumulated memory of the analyst, the equivalent ideal confined fission track for this combination of visible latent fission track tip and side traces. If the analyst is able to positively envision an equivalent ideal confined fission track for this combination of visible latent fission track tip and side traces, the analyst accepts the combination of visible latent fission track tip and side traces as a confined fission track and adds this new confined fission track to the accumulated memory of the analyst. The greater the fraction visible of properly positioned and oriented dissolved latent fission track side traces between the opposing dissolved latent fission track tip traces, the greater is the confidence of the analyst that this combination of visible latent fission track tip and side traces is a confined fission track. The analyst is never fully certain that these visible latent fission track tip and side traces are, in fact, a confined fission track and the current art does not include a means of quantifying the degree of certainty.

### PREFERRED EMBODIMENT OF THE INVENTION

Fission semi-tracks and confined fission tracks are commonly studied and their characteristics documented by an experienced analyst for the purpose of deciphering aspects of Earth's history. The preferred embodiment of the invention pertains to fission semi-tracks and confined fission tracks in natural apatite crystals or crystal fragments but the current invention may be applied to other natural solids in a similar manner.

Natural apatite, a common mineral in many types of Earth rocks, often contains trace amounts of fissile ²³⁸U nuclei. Henceforth, an individual apatite crystal or apatite crystal fragment is referred to as a crystal. Crystals or crystal fragments that have been liberated from their host rock are immersed in a polymeric epoxy, the polymeric epoxy is permitted to harden, and the crystals are then cut and polished using polishing grit to expose individual interior planes of the crystals. This configuration of crystals mounted in hardened polymeric epoxy is commonly referred to as a crystal mount.

Referring to FIG. 1, after polishing, the exposed interior planes of the crystals 1-1 are etched by immersing the crystal mount in dilute HNO₃ to make visible to the analyst any natural, ²³⁸U-derived fission semi-track 1-2. Where an appropriate etchant pathway 1-3 exists to permit the dilute HNO₃ to intersect an appropriately positioned and oriented confined latent fission track a confined fission track 1-4 is made visible to the analyst. Any fission semi-tracks 1-2 and confined fission tracks 1-4 are etched using 5.5N HNO₃ for 20.0 seconds (±0.5 seconds) at 21° C. (±1° C.) in the preferred embodiment of the invention. Other etching protocols may be used. The crystal mount may be irradiated with ²⁵²Cf-derived fission fragment nuclei prior to etching if the analyst desires additional etchant pathways that include ²⁵²Cf-derived fission semi-tracks to increase the likelihood of making visible confined fission tracks. Other high-energy nuclei may be used to produce additional etchant pathways.

In the preferred embodiment of the invention, the crystal mount and the visible features it contains are viewed by the analyst using a Nikon Optiphot2 optical microscope using either transmitted light, reflected light, or a combination of transmitted and reflected light at 1562.5x magnification. The analyst may directly view the crystal mount and the visible features it contains by looking through the microscope oculars or indirectly view the crystal mount and the visible features it contains by looking at a computer display screen containing a black and white or color visualization of the crystal mount and the visible features it contains made possible using a charge coupled device affixed to the microscope and interfaced with the computer. Other optical microscopes, magnifications, and charge coupled devices may be used by the analyst to directly or indirectly view the crystal mount and the visible features it contains. In the preferred embodiment of the invention, the analyst views the crystal mount and the visible features it contains on a computer display screen as prescribed and a static visualization on the computer display screen of the crystal mount and any visible elements it contains is commonly referred to as an image.

On the crystal mount, two visible and different points are separated by a fixed distance that can be expressed in a unit of length. On the image, these same two fixed points are separated by a fixed number of computer display screen pixels. In the preferred embodiment of the invention, the image for a given combination of optical microscope model, magnification, and charge coupled device is calibrated in both the horizontal (henceforth, X) and vertical (henceforth Y) directions yielding conversion factors in units of length/pixels. These conversion factors permit the distance between any two points on the image, separated by some number of computer display screen pixels, to be expressed in a unit of length. In the preferred embodiment of the invention, the unit of length is the micrometer but other units of length may be used.

In the preferred embodiment of the invention, the optical microscope is affixed with an apparatus that obtains a record of the relative height of the crystal mount within the optical pathways of the optical microscope. This apparatus is interfaced with the same computer to which the charge coupled device is interfaced. The relative crystal mount height within the optical pathways of the optical microscope is scaled such that any change in height of the crystal mount within the optical pathways of the optical microscope may be expressed in a unit of length. In the preferred embodiment of the invention, the unit of length is the micrometer but another unit of length may be used.

In the preferred embodiment of the invention, the height of the focal plane that intersects the optical pathways of the optical microscope is fixed at a fixed magnification. A change in height of the crystal mount within the optical pathways of the optical microscope represents an identical change in height of the crystal mount relative to the focal plane.

In the preferred embodiment of the invention, crystals 1-1 on the crystal mount are pre-viewed by the analyst and a subset of the crystals 1-5 containing fission semi-tracks 1-2 of interest to the analyst is specified and a second subset of crystals 1-6 containing confined fission tracks 1-3 of interest to the analyst is specified. The fission semi-track subset of crystals 1-5 and the confined fission track subsets of crystals 1-6 may be intermixed or they may be combined into a single subset of crystals.

Referring to FIG. 2, for each crystal specified by the analyst as containing fission semi-tracks 2-1 or confined fission tracks of interest 2-2, the crystal mount is positioned so that the specified crystal is approximately centered within the image on the computer display screen. The initial height of the crystal mount within the optical pathways of the optical microscope set so that the polished and etched plane of the host crystal containing the fission semi-track 2-1 or confined fission track 2-2 is at the height equal to the focal plane of the optical pathways of the optical microscope. In the preferred embodiment of the invention, the positioning of the initial height of the crystal mount is done using reflected light. Transmitted light with or without reflected light may be used for the initial height positioning. Reflected light is turned off and transmitted light is turned on and lighting is adjusted as needed by the analyst. The crystal mount is moved so that the focal plane is 1.0 micrometers away from the polished and etched plane of the host crystal and outside of the preserved volume of the host crystal. The data and/or signal transmitted by the charge coupled device to the computer required to present an image on the computer display screen are recorded for this grain mount position, a process henceforth referred to as recording an image. The crystal mount is then moved, in a series of 0.5 micrometer steps, so that the focal plane of the optical pathways of the optical microscope is moved toward the interior of the preserved volume of the host crystal. Each step represents a new position of the crystal mount within the optical pathways of the optical microscope and the image for each position is recorded. This process is ended when the focal plan is positioned 20.0 micrometers away from the polished and etched plane of the host crystal and within the preserved volume of the host crystal. Each recorded image is associated with a position (henceforth Z) relative to the polished and etched plane of the host crystal. Images recorded with the focal plane located outside the preserved crystal are associated with negative Z values, the absolute value of Z equal to the distance between the focal plane and the polished and etched crystal surface. Images recorded with the focal plane located inside the preserved volume of the host crystal are associated with positive Z values equal to the distance between the focal plane and the polished and etched crystal surface. Another starting distance, other than 1.0 micrometers, of the focal plane away from the polished and etched plane of the host crystal, may be used. Other step-wise movements, other than a fixed 0.5 micrometers, may separate adjacent positions of the polished and etched plane of the host crystal. Another ending distance, other than 20.0 micrometers, of the focal plane away from the polished and etched plane of the host crystal, may be used.

For each crystal specified by the analyst as containing fission semi-tracks 2-1 or confined fission tracks 2-2 of interest, the crystal mount is positioned so that the specified crystal is approximately centered within the image on the computer display screen. The crystal mount is then positioned so that the polished and etched plane of the host crystal containing the fission semi-track 2-1 or confined fission track 2-2 is at the height equal to the focal plane of the optical pathways of the optical microscope. In the preferred embodiment of the invention, this positioning of the crystal mount is done using reflected light. Transmitted light with or without reflected light may be used for this positioning. Transmitted light, if on, is turned off, reflected light is turned on, and lighting is adjusted as needed by the analyst. The crystal mount is moved so that the focal plane is 1.0 micrometers away from the polished and etched plane of the host crystal and outside of the preserved volume of the host crystal. The image is recorded for this grain mount position. The crystal mount is then moved, in a series of 0.5 micrometer steps, so that the focal plane of the optical pathways of the optical microscope is moved toward the interior of the preserved volume of the host crystal. At each step, the image is recorded for the grain mount position. This process is ended when the focal plan is positioned 20.0 micrometers away from the polished and etched plane of the host crystal and within the preserved volume of the host crystal. Another starting distance, other than 1.0 micrometers, of the focal plane away from the polished and etched plane of the host crystal, may be used. Other step-wise movements, other than a fixed 0.5 micrometers, may separate adjacent positions of the polished and etched plane of the host crystal. Another ending distance, other than 20.0 micrometers, of the focal plane away from the polished and etched plane of the host crystal, may be used.

In the preferred embodiment of the invention, the subset of crystals specified by the analyst for study of its fission semi-tracks is subjected to the prescribed processes of transmitted light image recording and reflected light image recording separately from the subset of crystals specified by the analyst for study of its confined fission tracks. Images are recorded for transmitted light followed by the recording of images for reflected light. It is possible to mix specified fission semi-track and confined fission track grains during image recording and it is possible to record images for transmitted light, then for reflected light, while at each specified crystal.

The transmitted light recorded images and reflected light recorded images for each of these crystal mount positions may contain one or more fission semi-track 2-1, one or more confined fission track 2-2, and any other feature of interest to the analyst including one or more of the following: etch figures, etched or un-etched fluid and/or mineral inclusions, etched cracks, etched disruptions or defects in the apatite crystal structure, and any part of an etchant pathway.

In the preferred embodiment of the invention, each pixel of the transmitted light recorded images and the reflected light recorded images is converted to its equivalent color on the gray scale with color ranging from black to white. The equivalent color is then converted to a number, black set equal to zero, white set equal to 255, and a color between black and white set equal to a value appropriate to the position of the color between black and white. Brightness refers to this gray scale number with a higher number having greater brightness. A visible feature in these images is defined by a brightness difference between adjacent pixels, a brightness gradient among pixels in a given direction, and/or a brightness curvature which is the rate of change of the brightness gradient among pixels in a given direction. The pixel information from the transmitted light and reflected light recorded images, including the original color, may be converted to different equivalent colors and/or different numerical values, and brightness may be defined in a different mathematical sense and other commonly used image processing concepts such as contrast may be used.

In the preferred embodiment of the invention, detecting and characterizing a particular visible feature requires limits to be set on the search area size over which a particular feature is sought for two dimensional features such as an etch FIG. 2-3, or the search volume size for three-dimensional features such as fission semi-tracks 2-1 and confined fission tracks 2-2. Once the search area or search volume size limits are set, a scheme is employed to move the search area through an image or the search volume through a series of images and execute the required test, specific to the particular type of feature sought, at each position of the search area or search volume. When results of the required test indicate the possible presence of a particular visible feature of interest, limits on the X and Y dimensions of the fitting window are generally set equal to three times the maximum dimension of the feature sought in its maximum state. The fitting window defines the area, in two dimensions, or volume when passed through adjacent images having different Z values, in which the mathematical procedures are executed to find and characterize the feature of interest. The mathematical procedures themselves involve the use of either public-domain, commercially available, or custom equations and/or computer algorithms. These equations and/or algorithms are generally designed to calculate the mathematical equation, such as a line or ellipse, that best fits a series of pixel X,Y coordinates, pixels defined by brightness differences between adjacent pixels, brightness gradients among pixels in a given direction, and/or brightness curvatures among pixels in a given direction. Limits are set on the length along the fitted equation, where appropriate, and width about the fitted equation imposed during execution of the equation fitting process and these limits may depend on the nature of the feature to which the equation fitting process pertains and/or pixel brightness characteristics within the fitting window and/or over the whole image. Other fitting window sizes and fitting equation length and width limits may be used. Other means of characterizing brightness variations over an image or series of images may be used as a basis for constraining the fitting equation length and width limits.

Each crystal possesses grain-wide characteristics that may be associated with all fission semi-tracks 2-1 and confined fission tracks 2-2 it may yield, including but not limited the equation of a line in X,Y,Z space that is parallel to the crystallographic c-axis of the crystal 2-4. It is common practice for the analyst to consider only crystals for which the crystallographic c-axis is parallel to or nearly parallel to the polished and etched crystal surface on the crystal mount. Etch FIGS. 2-3 visible in a transmitted or reflected recorded image of a crystal surface etched in 5.5N HNO₃ for 20.0 seconds (±0.5 seconds) at 21° C. (±1° C.) are elongate in the direction of the crystallographic c-axis 2-4 and parallel or nearly parallel to one another if the c-axis direction 2-4 is parallel to or nearly parallel to the polished and etched plane of the crystal. Nearly parallel is commonly viewed to indicate within 10 degrees but another definition of nearly parallel may be used. Referring to FIG. 3, etch FIGS. 3-1 for fission semi-tracks 3-2 for a single crystal exhibit maximum diameters (henceforth, Dpar values) 3-3 parallel to the direction of the crystallographic c-axis 3-4 and minimum diameters (henceforth, Dper values) 3-5 perpendicular to the direction of the crystallographic c-axis 3-4. Etch FIGS. 3-1 are identified in the transmitted light or reflected light image for which Z equals zero by passing the search area over the image and finding closed geometrical figures made visible by differences in brightness. Ellipses are fitted to these closed geometrical figures and a histogram of the major axes of all fitted ellipses may be plotted. Generally, the histogram peak exhibiting the smallest mean value is composed of Dpar values 3-3 for fission semi-tracks 3-2 and other etched features such as some types of crystallographic lattice imperfections that yield etch figure dimensions similar to etch FIGS. 3-1 from fission semi-tracks 3-2. The mean Dpar 3-3 value and its standard deviation for the crystal are set equal to the mean and standard deviation of the individual Dpar 3-3 values that contribute to the histogram peak exhibiting the smallest mean value. The mean Dper 3-5 value and its standard deviation for the crystal are set equal to the mean and standard deviation of the Dper 3-5 values that are associated with the Dpar 3-3 values used to calculate the mean Dpar 3-3 value and its standard deviation for the crystal. The analyst may be presented with the option to accept or reject any or all individual Dpar 3-3 and Dper 3-5 values that are used to calculate the mean Dpar 3-3 value and its standard deviation and mean Dper 3-5 and its standard deviation for the crystal. Other geometrical figures may be fitted to the etch FIGS. 3-1 including polygons such as a rectangle or hexagon and other statistical measures may be used as estimates of the Dpar 3-3 and Dper 3-5 values for the crystal including median or mode.

The major axes of the ellipses fitted to the etch FIGS. 3-1 for the crystal should be largely parallel to each other if the direction of the crystallographic c-axis 3-4 of the crystal is parallel or nearly parallel to the polished and etched plane of the crystal. In the preferred embodiment of the invention, each fitted ellipse major axis may be either parallel to the Y-axis of the recorded image or it exhibits an acute or right angle at its intersection with the Y-axis. The offset of the crystallographic c-axis of the crystal relative to the Y-axis is taken as the median angle of these fitted ellipse major axis offset angles. The standard deviation of the estimate of the offset of the crystallographic c-axis is taken as the standard deviation of the individual fitted ellipse major axis offset angles about the median offset angle value. The analyst may be presented with the option to accept or reject any or all individual fitted ellipse major axis offset angles used to calculate the offset angle of the crystallographic c-axis of the crystal from the Y-axis of the recorded image. Other statistical measures may be used to estimate the offset angle of the crystallographic c-axis of the crystal from the Y-axis of the recorded image including the mean or mode.

Referring to FIG. 2, in the preferred embodiment of the invention, the process of searching for and characterizing a confined fission track 2-2 begins by moving the search volume through the transmitted light recorded images. The first of several required tests involves detecting the first of two required etched latent fission track tips 2-5, characterized by a pattern of brightness variations among pixels within a 5.0 micrometer search sphere that exhibit approximately parabolic shape. When such an etched latent fission track tip 2-5 is detected, a parabola is fitted to a subset of the pixels that exhibit approximately parabolic shape, the subset being those pixels that define the steepest brightness gradients in both the X and Y directions. The fitted parabola is defined by three fitted coefficients. The three fitted coefficients are used to calculate the X,Y,Z position of the vertex of the parabola and this position is equated to the position of the end of the first etched latent fission track tip 2-5. The three fitted coefficients are used to calculate the line containing the axis of the parabola. The direction in which the second etched latent fission track tip may reside is the direction along the line containing the axis of the parabola toward which the parabola opens. Standard deviations of the three fitted coefficients of the parabola are also calculated and they are used to calculate the uncertainty in the position of the first etched latent fission track tip 2-5 and the uncertainty of the direction line toward the second etched latent fission track tip 2-6. The uncertainties of the vertex and/or direction of the line toward the second etched latent fission track tip 2-6 may also be calculated by comparing brightness variations in the vicinity of the calculated vertex to brightness variations of other parts of the first etched latent fission track tip 2-5 or other visible features. The second required test involves moving the search volume within a right circular cone whose axis is contained by the line containing the axis of the fitted parabola of the first etched latent fission track tip and having apex angle of 45 degrees and at a distance no greater than 20.0 micrometers from the X,Y,Z position of the first etched latent fission track tip 2-5 and seeking the second 2-6 of two required etched latent fission track tips, characterized by a pattern of brightness variations among pixels within a 5.0 micrometer search sphere that exhibit approximately parabolic shape. Other apex angles may be used. If a second etched latent fission track tip 2-6 is found within the right circular cone, using the required test prescribed for finding the first etched latent fission track tip 2-5, a parabola is fitted to a subset of the pixels that exhibit approximately parabolic shape defining the second etched latent fission track tip and its vertex X,Y,Z position and uncertainty and the line containing its axis and the uncertainty on its direction are determined as prescribed for the first etched latent fission track tip 2-5. If the parabola of the second etched latent fission track tip 2-6 opens toward the vertex of the first etched latent fission track 2-5, the first 2-5 and second 2-6 etched latent fission track tips are deemed opposing and the opposing latent fission track tip traces are considered opposing potential confined fission track tip traces. If opposing potential confined fission track tips are found, evidence of visible side traces 2-7 of an etched latent fission track between the opposing potential confined fission track tips is sought. The search area for the third test is defined as a rectilinear area twice as wide as the crystal Dpar 2-8 value, centered on and including the line segment connecting is the first potential confined fission track tip 2-5 to the second potential confined fission track tip 2-6. The third test involves searching for and fitting line segments to any found linear patterns of brightness variations among pixels within the search area. Any line segments within 10 degrees offset orientation from the line segment connecting first potential confined fission track tip to the second potential confined fission track tip are considered potential confined fission track side traces 2-7 that connect the two potential confined fission track tips 2-5 2-6. The greater the degree of connection among the potential confined fission track side traces 2-7 to each other and to the two potential confined fission track tip 2-5 2-6 traces, the greater the likelihood that these traces combined represent a confined fission track 2-2. The results of these tests may be presented to the analyst and the analyst may decide whether or not the potential confined fission track side 2-7 and tip 2-5 2-6 traces represent a confined fission track 2-7 as envisioned by the analyst for the equivalent ideal confined fission track and if the decision is affirmative, the images of the confined fission track are added to the database of confined fission tracks (henceforth, confined fission track database) that is stored in a data storage device.

The greater the number of confined fission tracks 2-2 in the confined fission track database, the greater is the accumulated experience available to the computer program from which the confined fission track scoring algorithm may be developed and refined and to which new potential confined fission tracks 2-2 may be compared. In the preferred embodiment of the invention, a confined fission track scoring algorithm is available which seeks to estimate the relative likelihood that a combination of characterized potential confined fission track tip 2-5 2-6 and side 2-7 traces would be decided in the affirmative to be a confined fission track 2-2 by the analyst. The confined fission track scoring algorithm utilizes all available information concerning the potential confined fission track. This information includes the Dpar 3-3 and Dper 3-5 values for the host crystal, the length and its uncertainty of the potential confined fission track 2-2, defined as the distance and its uncertainty between its two tips, the angle and its uncertainty of the potential confined fission track axis, defined as the line segment connecting its two potential confined fission track tips 2-5 2-6, to the direction of the crystallographic c-axis 2-4, the inclination angle of the potential confined fission track axis to the polished and etched plane of the crystal, the depths of the two potential confined fission track tips 2-5 2-6 below the polished and etched plane of the crystal, the degree of alignment and overlap of the axes of the two fitted parabolas used to calculate the two potential confined fission track tip 2-5 2-6 positions, the degree to which geometrical figure formed by the potential confined fission track tip 2-5 2-6 traces and intervening confined fission track side 2-7 traces resembles the closed figure likely to be envisioned by the analyst for its equivalent ideal confined fission track, the degree of smoothness of the confined fission track side 2-7 traces, and the number and type of etchant pathways 2-9. The weighting of this information in the confined fission track scoring algorithm varies with the type of information. Potential confined fission track 2-2 length, potential confined fission track 2-2 axis angle to the direction of the crystallographic c-axis 2-4, crystal Dpar 3-3 and Dper 3-5 values, and the degree to which the potential confined fission track tip 2-5 2-6 and side 2-7 traces represent the closed geometrical figure of an ideal confined fission track are of greatest importance. The algorithm, including how it weights each bit of information, is periodically updated as new images of confined fission tracks 2-2 are added to the confined fission track database. A confined fission track database containing images of tens of thousands confined fission tracks 2-2, combined with an experience-based confined fission track scoring algorithm that is optimized to provide the highest overall score to the stored confined fission tracks is likely to reach a condition where a potential confined fission track having a score above some score threshold is 99 percent likely, or some other percentage of interest to the analyst, to be decided in the affirmative by the analyst to be a confined fission track. At some point, the analyst may become sufficiently confident in the confined fission track database and associated confined fission track scoring algorithm to accept as confined fission tracks potential confined fission tracks having a score above some threshold.

In the preferred embodiment of the invention, the confined fission track scoring algorithm may present to the analyst an estimate of probability that a potential confined fission track is a real confined fission track. The computer program containing the confined fission track scoring algorithm presents to the analyst the ability to accept this estimate of probability or override this estimate with a value specified by the analyst.

In the preferred embodiment of the invention, the confined fission track database is searchable. Search indices may include the identity of the analyst who decided to add the images of the confined fission track 2-2 to the confined fission track database, Z value of each image, the probability that the confined fission track images represent a real confined fission track, the crystal Dpar and Dper values, confined fission track length, confined fission track angle to the crystallographic c-axis, confined fission track inclination angle to the polished and etched plane of the crystal, confined fission track tip depths below the polished and etched plane of the crystal, the overlap or lack thereof of the axes of the two fitted parabolas used to calculate the two potential confined fission track tip positions, the degree to which geometrical figure formed by the potential confined fission track tip traces and intervening confined fission track side traces resembles the closed figure likely to be envisioned by the analyst for its equivalent ideal confined fission track, the degree of smoothness of the confined fission track side traces, and the number and type of etchant pathways. If new or revised methods of evaluating these parameters or others are developed and/or as the confined fission track scoring algorithm is developed and refined, confined fission track images may be reprocessed through the new methods and/or new confined fission track scoring algorithm may be modified to reflect the new information.

In the preferred embodiment of the invention, the confined fission track database is specific to the identity of the analyst that made the decision to add each set of images of a confined fission track to the confined fission track database. Each set of images of a confined fission track in the confined fission track database is transferable to an analyst having a different identity on the condition that there is consensus between the two analysts that the images represent a confined fission track.

In the preferred embodiment of the invention, new potential confined fission tracks may be scored against a confined fission track database where two or more analysts agree by consensus that each confined fission track in the confined fission track database is a confined fission track. A consensus group is composed of two or more analysts contributing to a confined fission track database containing images of confined fission tracks agreed to by consensus.

In the preferred embodiment of the invention, confined fission tracks may be sorted according to any of the available types of information including but not limited to analyst identity or consensus group, the probability a confined fission track is actually a confined fission track, and the overall score produced by the confined fission track scoring algorithm. A subset of the confined fission tracks meeting specified sorting criteria applied to the available types of information and/or specified confined fission track scoring criteria may be selected for purposes of deciphering aspects of Earth's history.

In the preferred embodiment of the invention, a computer program is made available to the analyst to aid the analyst with the decision whether a potential confined fission track is a real confined fission track. This program presents to the analyst images of the potential confined fission track on a computer display screen and allows the recall of images from the confined fission track database. Images of the potential confined fission track may be presented on the computer display screen simultaneously with recalled images of a confined fission track from the confined fission track database or they may be displayed separately or at different times at the choosing of the analyst. Images of the potential confined fission track and recalled confined fission track from the confined fission track database are presented to the analyst with crystallographic orientation normalized whereby the crystallographic c-axis directions for the associated images are aligned in the Y direction of the computer display screen. Images of the potential confined fission track and recalled confined fission track from the confined fission track database are presented to the analyst with confined fission track position normalized whereby the mid-points of the potential confined fission track and recalled confined fission track axes are placed at the center of the image displayed on the computer display screen. Images of the potential confined fission track and recalled confined fission track from the confined fission track database are presented with X and Y direction length scales normalized whereby they present to the analyst the same X and Y direction length scales for the associated images. Other means of normalizing images of the potential confined fission track and recalled confined fission track from the confined fission track database may be used. The computer program presents to the user the option of viewing a series of confined fission track images from the confined fission track database whereby the series is defined by specified sorting criteria applied to the available types of information and/or specified confined fission track scoring criteria. The computer program presents to the analyst the option of parsing through the series of confined fission track images from the confined fission track database and the option to modify the specified sorting criteria applied to the available types of information and/or specified confined fission track scoring criteria defining the series of confined fission track images. This ability to compare images of a potential confined fission track to images of recalled confined fission tracks from the confined fission track database provide a basis for an experienced analyst to train an inexperienced analyst.

In the preferred embodiment of the invention, available information for a confined fission track includes various uncertainty values including but not limited to the probability that the confined fission track is actually a confined fission track and the uncertainties on confined fission track length and confined fission track axis offset angle from the crystallographic c-axis. Other uncertainties include grain-scale values such as the uncertainties of crystal Dpar and Dper values. These uncertainties may be passed on to any method of interpretation that utilizes the confined fission track for purposes of deciphering aspects of Earth's history. Uncertainties may be passed to the method of interpretation using standard statistical protocols and/or they may be passed to the method of interpretation using numerical methods such as a Monte Carlo simulation. As the confined fission track database becomes larger and the confined fission track scoring algorithm is developed further and refined, the understanding of these uncertainties by the analyst will increase and the means of passing them to the method of interpretation will improve and the ultimate result is that the means of deciphering aspects of Earth's history that utilizes the confined fission track will improve.

1. A method of determining the positions of the tips of a confined fission track in a crystal comprising the steps of: capturing light transmitted through the crystal when the focal plane is at each of a series of known positions to produce a series of transmitted light images; detecting the two tips of the confined fission track; determining the positions in the crystal of the two tips of the confined fission track.

2. A method as defined in claim 1 wherein the step of capturing light transmitted through the crystal to produce a series of transmitted light images includes the steps: imaging a plane containing the first of the two tips of the confined fission track; imaging a plane containing the second of the two tips of the confined fission track.

3. A method as defined in claim 2 wherein both steps of imaging a plane containing a tip of the confined fission track includes the steps: determining transmitted light brightness gradient values from the transmitted light images and near the tip of the confined fission track; detecting the tip of the confined fission track based on the transmitted light brightness gradient values; fitting a mathematical equation to a series of transmitted light gradient values from the transmitted light images and near the tip of the confined fission track.

4. A method as defined in claim 3 wherein the step of fitting a mathematical equation to a series of transmitted light brightness gradient values from the transmitted light images and near the tip of the confined fission track includes the steps: determining the statistical uncertainty of the mathematical equation fitted to the series of transmitted light brightness gradient values from the transmitted light images and near the tip of the confined fission track; accepting or rejecting as being real the tip of the confined fission track based on the statistical uncertainty of the mathematical equation fitted to the series of transmitted light brightness gradient values from the transmitted light images and near the tip of the confined fission track.

5. A method as defined in claim 4 also comprising the step of accepting or rejecting as being real the tip of the confined fission track based on the judgment of a human being.

6. A method as defined in claim 3 also comprised of the steps: calculating the respective position in the crystal of each tip of the confined fission track from the respective fitted mathematical equation for each tip of the confined fission track; calculating the respective statistical uncertainty of the position in the crystal of each tip of the confined fission track from the respective statistical uncertainty of the fitted mathematical equation for each tip.

7. A method as defined in claim 1 also comprising the steps: capturing light reflected from the crystal when the focal plane contains the polished and etched crystal surface to produce a reflected light image; determining reflected light brightness gradient values from the reflected light image and near an etch figure; fitting a mathematical equation to a series of reflected light gradient values from the reflected light image and near an etch figure; determining the statistical uncertainty of the mathematical equation fitted to a series of reflected light gradient values from the reflected light image and near an etch figure; determining the size of an etch figure in the reflected light image.

8. A computer software program for detecting a confined fission track in a crystal comprising instructions for: loading a series of transmitted light images formed by the transmission of light through a crystal; detecting the two tips of a confined fission track from the transmitted light brightness gradient values from the transmitted light images; writing transmitted light images to a computer database; loading transmitted light images from a computer database.

9. A computer software program as defined in claim 8 and also comprising instructions for: fitting a mathematical equation to a series of transmitted light brightness gradient values from the series of transmitted light images and near a tip of a confined fission track; assessing the viability, using a scoring equation, of a tip of a confined fission track based on the statistical uncertainty of the mathematical equation fitted to a series of transmitted light brightness gradient values from the series of transmitted light images and near a tip of a confined fission track.

10. A computer software program as defined in claim 8 wherein writing transmitted light images to a computer database and loading transmitted light images from a computer database also comprises instructions for: writing a transmitted light image containing a tip of a confined fission track; loading one transmitted light image containing a tip of a confined fission track; loading two or more transmitted light images, each transmitted light image containing a tip of a confined fission track.

11. A computer software program as defined in claim 10 wherein loading two or more transmitted light images, each transmitted light image containing a tip of a confined fission track also includes instructions for: modifying the scoring equation for assessing the viability of a tip of a confined fission track.

12. A computer software program as defined in claim 8 and also comprising instructions for presenting to a human being for viewing by the human being a transmitted light image of the tip of a confined fission track.

13. A computer software program as defined in claim 8 and also comprising instructions for calculating the statistical probability that a confined fission track is a real confined fission track.

14. A computer database of confined fission tracks comprised of: allowing a confined fission track to be inserted; allowing a confined fission track to be removed; representing each confined fission track in the database by one or more transmitted light images formed by the transmission of light through a crystal.

15. A computer database of confined fission tracks as defined in claim 14 and also comprised of assigning to each inserted confined fission track a statistical probability that the confined fission track is a real confined fission track.

16. A computer database of confined fission tracks as defined in claim 14 and also comprised of: restricting the insertion of all confined fission tracks to a human being; restricting the removal of a confined fission track to the same human being to which insertion of confined fission tracks is restricted.

17. A computer database of confined fission tracks as defined in claim 14 and also comprised of: restricting the insertion of all confined fission tracks to a any member of a group of human beings; restricting the removal of a confined fission track to any member of the same group of human beings to which insertion of confined fission tracks is restricted.

18. A method of determining the statistical probability that a confined fission track is a real confined fission track, comprised of: capturing light transmitted through the crystal when the focal plane is at each of a series of known positions to produce a series of transmitted light images; detecting the two tips of the confined fission track; detecting the two sides of the confined fission track; assessing the viability of each confined fission track tip; assessing the viability of each confined fission track side.

19. A method of determining the statistical probability that a confined fission track is a real confined fission track as defined in claim 18 also comprising the steps of assessing the viability, using a scoring equation, of a tip of a confined fission track based on the statistical uncertainty of the mathematical equation fitted to a series of transmitted light brightness gradient values from the series of transmitted light images and near a tip of a confined fission track; assessing the viability, using a scoring equation, of a side of a confined fission track based on the statistical uncertainty of the mathematical equation fitted to a series of transmitted light brightness gradient values from the series of transmitted light images and near a side of a confined fission track.

20. A method of determining the statistical probability that a confined fission track is a real confined fission track as defined in claim 18 also comprising the steps of: assessing the viability of each confined fission track tip based on the judgment of a human being; assessing the viability of each confined fission track side based on the judgment of a human being.

21. A method of determining the statistical probability that a confined fission track is a real confined fission track as defined in claim 18 also comprising the steps of: assessing the viability of each confined fission track tip based on the collective judgment of a group of human beings; assessing the viability of each confined fission track side based on the collective judgment of a group of human beings.
